(19) United States
(12) Patent Application Publication
(10) Pub. No.: US 2007/0112747 A1
(43) Pub. Date: May 17, 2007

(54) Method and apparatus for identifying data of interest in a database

(75) Inventors: Karen Z. Haigh, Greenfield, MN (US); Valeric Guralnik, Orono, MN (US); Wendy K. Foslien, St. Paul, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/274,774

(22) Filed: Nov. 15, 2005

(51) Int. Cl. G06F 17/30

(52) U.S. Cl. 707/4

(57) ABSTRACT

Templates for use in searching for data segments of interest in stores of data are defined and/or refined by analyzing related matches, extracting common or key elements, and/or generalizing or modifying the templates. This process can involve calculating the similarity between matches, clustering matches, and identifying key elements for defining and/or refining templates and/or search parameters. A user may interact with a software tool for refining templates.

### FIELD

The present invention relates to database searching, and more particularly, to identifying data of interest within a database.

### BACKGROUND

Many domains collect relatively large amounts of data. In many cases, it is desirable to be able to identify and select only certain data from the database. This is often accomplished by providing a tool that can search through the data to find these data that match a user defined query. The data may include natural language text, image, numerical, or other formats.

Many technologies have been developed to search through and identify certain data in a database. In some cases, the database can be both broad and deep. As a result, many existing techniques for extracting meaningful data can be time consuming and tedious. One of the difficulties associated with identifying data of any type is the specification of an appropriate search definition or query. An “appropriate” search definition or query maximizes the likelihood of accurate or desired results while minimizing false positive matches.

Many different techniques have been used to find data of interest in a database. When the database includes text data, the user may specify a set of keywords or a natural language phrase that is used to find text matches within the database. For image data, the user may specify visual shapes, a color spectrum, or keywords of objects in the image. For numerical data, the user may specify shapes, thresholds, or numerical functions to find certain data. For some forms of data, a search for “similar” data may be desired, e.g. “find more images/documents like this one.”

The set of matches that are identified by a particular search definition or query often are not exactly what the user was looking for, sometimes because the query was poorly specified. In many cases, matches do not have to be identical to the original query, but only contain some relationship with the query. In general, it may be tedious to construct good queries by hand, and moreover, there may be other data of interest that are not easily described by the user in a search query, and/or the user is simply unaware that such data of interest is present in the database. In addition, the user may not really know how effective the search is—for example, important matches may be missed because they are slightly outside of the specified search query, outside search parameter settings, or have an intolerably high rate of false positives.

In many systems, it is the user's responsibility to define and/or refine the query to obtain the desired results. Brute force methods for automatically refining the query have been discussed in the art, and involve searching a data store for all potential matches, finding the probabilities for each pattern, and sorting the results. These methods often require large amounts of resources and are impractical to implement in many cases.

### SUMMARY

The present invention provides improved systems and methods for identifying data of interest within a database. In one illustrative embodiment, templates for use in searching for data of interest within a database can be defined and/or refined automatically or semi-automatically. A template may be defined as a structure that holds a search definition or query, and may include search or other parameters. In some cases, one or more templates may be defined and/or refined automatically or semi-automatically by, for example, identifying one or more relationships in the matching data elements contained in the search results, analyzing closely related matches within the search results, extracting common or key elements from the search results, or otherwise generalizing or modifying one or more templates based on the search results. In some cases, this may involve calculating the similarity between matches within a search result, clustering matches, and/or identifying key elements for defining and/or refining templates and/or search parameters. New or refined templates may then be run against the database to generate new and possibly more appropriate search results. In some cases, a user may interact with a software tool to help define and/or refine the search templates.

### BRIEF DESCRIPTION OF THE DRAWINGS

FIG. 1 is a flow chart illustrating a method of defining and/or refining templates for use in searching time series data according to an illustrative embodiment of the present invention;

FIG. 2 is a block diagram of an example computer system for implementing various illustrative embodiments of the present invention;

FIG. 3 illustrates multiple templates for time series data representative of motor current according to an illustrative embodiment of the present invention;

FIG. 4 illustrates multiple alphabet templates according to an illustrative embodiment of the present invention;

FIG. 5 illustrates a similarity matrix according to an illustrative embodiment of the present invention;

FIG. 6 illustrates example matches for selected templates according to an illustrative embodiment of the present invention;

FIG. 7 illustrates a dendrogram for the templates shown in FIG. 3;

FIG. 8 illustrates a template for an illustrative embodiment of numerical time series data, and two matches that may be used to form a new candidate template; and

FIG. 9 illustrates joining templates according to an illustrative embodiment of the present invention.

### DETAILED DESCRIPTION

1. Introduction

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software may include computer executable instructions stored on computer readable media such as memory or other type of storage devices. The term “computer readable media” is also used to represent carrier waves on which the software is transmitted. Further, such functions may correspond to modules, which are software, hardware, firmware or any combination thereof. Multiple functions may be performed in one or more modules as desired, and the illustrative embodiments described herein are merely examples. The software may be executed on a digital signal processor, ASIC, microprocessor, or any other suitable type of processor operating on a computer system, such as a personal computer, server or other computer system.

The following paragraphs describe an overview of the invention and a computer system for storing and executing software in accordance with illustrative embodiments of the invention. A description of the use of similarity metrics is then described. Similarity metrics can be used to, for example, determine relationships between templates. Multiple methods of refining the templates are also described.

1.1 Data & Template Overview

We describe an approach for automatically or semi-automatically defining templates for searching through stores of data. The data might include text, images, audio, numerical values, and/or other formats, as desired. The data might include, for example, a set of web pages, a set of call center databases, a collection of faces, a collection of maps, a collection of sensor data, a purchase transaction database, financial stock values, or any other suitable database or databases. In one illustrative embodiment, the data may be stored in a database that includes time series data used to track variables over relatively long expanses of time or space, such as is common in chemical plants, refineries, building control, engine data, etc. In some of these applications, hundreds of time series variables may be tracked and used for optimization, control system diagnosis, abnormal event analysis, and/or any other suitable purpose.

A template may be defined as a structure that holds a search definition or query, and may include search or other parameters. A template may be used to search through data in a database and identify “matches”. A match does not need to be identical to the original template, but may be related in some way. For example, in text data, the template might be a set of keywords or a document, which may identify text data that is related in some way to the set of keywords or the document. Likewise, in image data, the template might be a specific visual shape or color spectrum. In numerical data, the template may be a sequence of points that form a shape, possibly in multi-dimensional space, or a mathematical formula that describes a shape. The template might be relatively small and precise (e.g. keywords) or might reflect a greater concept (e.g. a document, where the user asks for “more like this”).

A template may have search parameters that indicate search flexibility, or a degree to which matches need to be similar to the template. For example, a textual template may indicate case sensitivity, the physical proximity of words to one another, degree of misspelling allowed, number of words that must match the template, the relative weights for different parts of speech (noun, verb, adjective, etc), etc. For numerical data, some example parameters may include the degree to which the duration of an event must match (compress and expand), the degree to which the amplitude of an event must match (grow and shrink), a down sample ratio which controls resolution, the degree to which coefficients in the formula may change, expected periodicity, etc.

The templates may be automatically or semi-automatically defined and/or refined by, for example, identifying one or more relationships in matching data elements contained in search results, analyzing closely related matches within the search results, extracting common or key elements from the search results, or otherwise generalizing or modifying one or more templates based on the search results. In some cases, this may involve calculating the similarity between matches within a search result, clustering matches, and/or identifying key elements for defining and/or refining templates and/or search parameters. New or refined templates may be run against the database to generate new and possibly more appropriate search results. In some cases, a user may interact with a software tool to help define and/or refine the search templates.

1.2 Software Overview

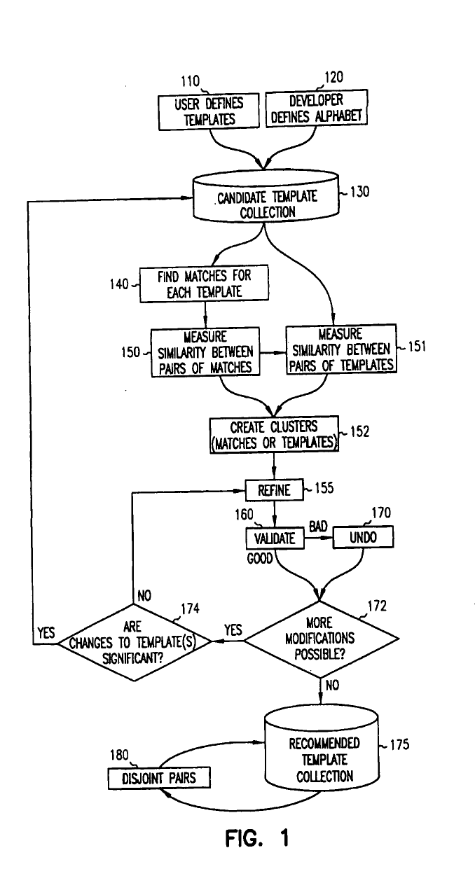

FIG. 1 illustrates the selection of templates, searching, and refining templates at a high level. Templates may be defined by users as indicated at 110. For example, templates may be created by the user, or selected from a list of known/suggested templates or otherwise obtained. In one illustrative embodiment, users may use existing tools to view the data, and select interesting patterns to create templates. One such method is described in U.S. Pat. No. 6,754,388 to Foslien et al., which is incorporated herein by reference. Alternatively, or in addition, an alphabet of templates or patterns may be created or selected, as indicated at 120. In the illustrative embodiment, the selected template or templates are stored in a candidate template collection storage device 130.

In some cases, an optional search of the database for patterns that match the selected template or templates is performed at 140. This search may be optionally broadened by loosening the search parameters to increase the number of matches found for each template. This may help ensure that interesting matches, possibly missed by a narrower search, are more likely to be included when the first set of templates is refined (see below).

In some cases, one or more relationships may be identified between the matching data elements for each template. Then, one or more new templates may be defined, or one or more of the selected templates may be refined, based at least part on the identified one or more relationships in the matching data elements.

In the illustrative embodiment of FIG. 1, a similarity between pairs of matches is determined at 150 (or pairs of templates in 151), and is quantified by one or more similarity metrics. This information may help with the creation of clusters of matches or templates at 152, based on the similarity metrics. The clusters may be thought of as “families” of templates or matches that share one or more common characteristics. In one illustrative embodiment, a dendrogram or similarity matrix may be constructed on the matches to illustrate the relationships between the clusters, matches and/or templates.

In one illustrative embodiment, the clusters of related matches or templates may be used to extract common or key elements at 155 of FIG. 1. The algorithm or the user can then use these relationships to create a possibly different set of new or refined templates that may be more effective at identifying the data of interest. Many different techniques, some of which are described below, may be used to form the new templates, depending on the specific data in question.

At 160, the new and/or refined templates may be validated (either individually or as a group) to ensure that new and/or refined templates are at least as good as the previous (set of) template(s). If the new and/or refined templates are considered “bad,” then the most recent refinement step at 170 is undone. If further modifications are possible at 172, the templates may be modified. At block 174, if changes were relatively minor, block 155 may be reentered to continue creating new and/or refined templates based on the known cluster information; otherwise block 130 may be reentered to recalculate matches, similarities and/or clusters. If no further modifications are desired at 172, the new and/or refined template(s) may be added to the recommended template collection at 175. In some embodiments, and for certain kinds of data, templates may be created that represent disjoint pairs, as shown in block 180.

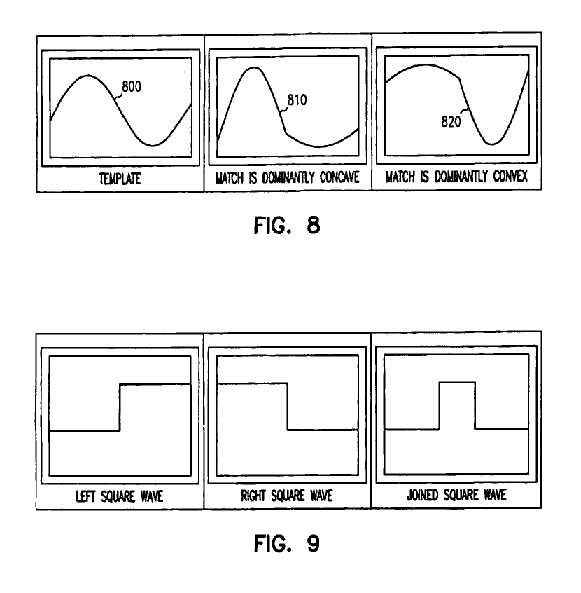

To illustrate the results of the illustrative algorithm, consider a template search query through web pages for “java coffee.” An internet search engine may return two main clusters of web pages: (a) those describing the beverage coffee made from java coffee beans, and (b) those describing the programming language Java. These clusters are determined using the contents of the items returned by the search engine. Examining the clusters of matches, the illustrative algorithm might identify additional key words from the matches such as “mocha,” “roaster,” “grinder,” “water” and “cup” for the first cluster of matches, and “tutorial,” “application,” “client” and “program” for the second cluster, and also identify irrelevant or misleading keywords such as “coffee” for the second cluster. The, recommended template collection 175 may then include two new templates: “java coffee mocha roaster grinder water” and “java tutorial application client program.” Similarly, “windows” might generate clusters for “windows computer” and “windows glass.” Alternatively, in one embodiment for time series data, a “sine wave” template illustrated in, for example, FIG. 8 at 800, might yield two clusters, one matching the concave portion at 810, the another matching the convex portion at 820. Each cluster of matches may become a candidate “new” or refined template.

1.3 System Hardware Overview

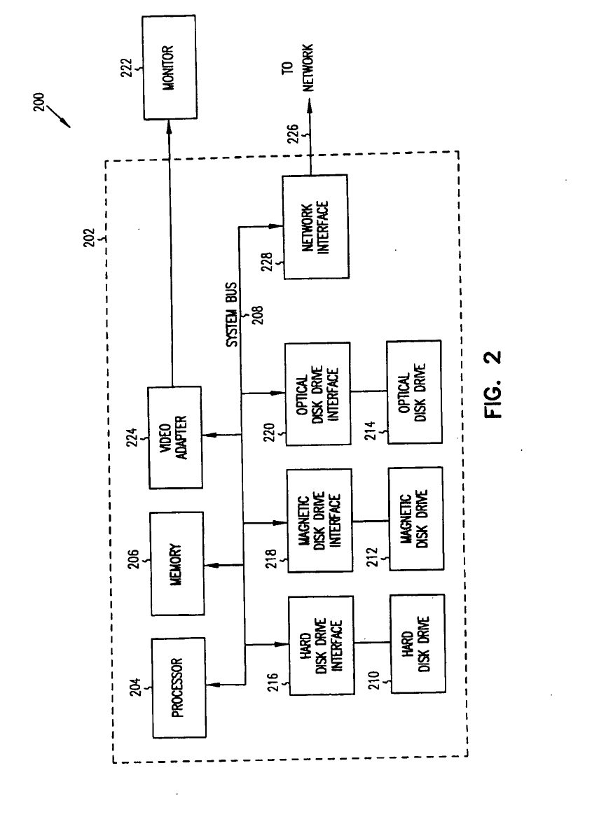

FIG. 2 depicts an illustrative computer arrangement 200 for analyzing a data sequence. This computer arrangement 200 includes a general purpose computing device, such as a computer 202. The illustrative computer 202 includes a processing unit 204, a memory 206, and a system bus 208 that operatively couples the various system components to the processing unit 204. One or more processing units 204 operate as either a single central processing unit (CPU) or a parallel processing environment.

The illustrative computer arrangement 200 further includes one or more data storage devices for storing and reading program and other data. Examples of such data storage devices include a hard disk drive 210 for reading from and writing to a hard disk (not shown), a magnetic disk drive 212 for reading from or writing to a removable magnetic disk (not shown), and an optical disc drive 214 for reading from or writing to a removable optical disc (not shown), such as a CD-ROM or other optical medium.

The hard disk drive 210, magnetic disk drive 212, and optical disc drive 214 are connected to the system bus 208 by a hard disk drive interface 216, a magnetic disk drive interface 218, and an optical disc drive interface 220, respectively. These drives and their associated computer-readable media provide nonvolatile storage of computer-readable instructions, data structures, program modules, and other data for use by the computer arrangement 200. Any type of computer-readable media that can store data that is accessible by a computer, such as magnetic cassettes, flash memory cards, digital versatile discs (DVDs), Bernoulli cartridges, random access memories (RAMs), and read only memories (ROMs) can be used, as desired.

A number of program modules can be stored or encoded in a machine readable medium such as the hard disk, magnetic disk, optical disc, ROM, RAM, or an electrical signal such as an electronic data stream received through a communications channel. These program modules may include an operating system, one or more application programs, other program modules, and program data.

A monitor 222 may be connected to the system bus 208 through an adapter 224 or other interface. Additionally, the computer arrangement 200 can include other peripheral output devices (not shown), such as speakers and printers.

The illustrative computer arrangement 200 can operate in a networked environment using logical connections to one or more remote computers (not shown). These logical connections may be implemented using a communication device coupled to or integral with the computer arrangement 200. In some cases, the data sequence to be analyzed can reside on a remote computer in the networked environment, but this is not required. The remote computer can be another computer, a server, a router, a network PC, a client, or a peer device or other common network node. FIG. 2 depicts the logical connection as a network connection 226 interfacing with the computer arrangement 200 through a network interface 228. Such networking environments are commonplace in office networks, enterprise-wide computer networks, intranets, and the Internet, which are all types of networks. It will be appreciated by those skilled in the art that the network connections shown are provided by way of example and that other means of and communications devices for establishing a communications link between the computers can be used.

2. Template Design & Refinement

2.1 Defining Templates (Blocks 110, 120 of FIG. 1)

As noted above, templates may be defined as structures that hold search definitions or queries, and may include search or other parameters. In one illustrative embodiment, an algorithm is provided that assists in the creation of a “good” set of templates. In this illustrative embodiment, a (set of) seed template(s) is initially provided or selected. Many methods may be used to initially define and/or select the seed template(s), including specification by a user, creation of a collection of relevant patterns, or extracts of relevant data from the database, to name a few.

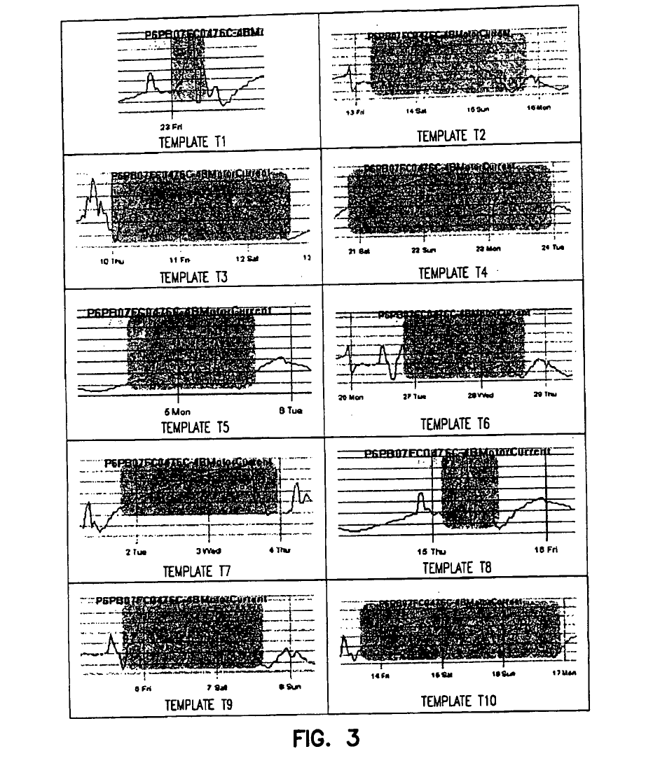

For example, the user may create a seed template(s). If the data store is textual, the user may simply specify a set of keywords or phrases to define the seed template(s). If the data store is time series data, the user may graphically specify a set of data to represent the seed template(s). Examples of ten templates for time series data related to a motor current are shown in FIG. 3. Visually, one can see that templates (T1, T5 and T8) are closely related, as are (T4 and T10 and possibly T7), and (T2, T3, T6, and T9).

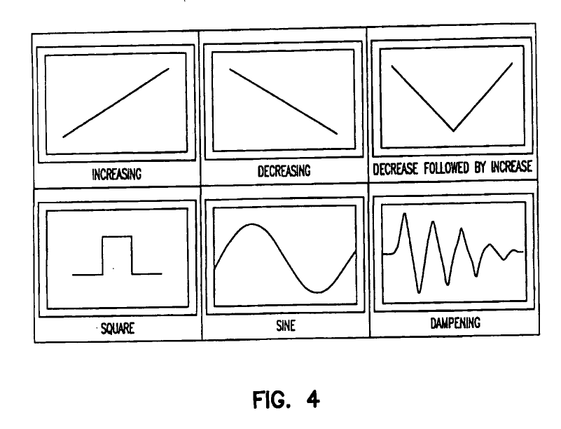

In a further embodiment, a set of “alphabet” templates of patterns may be created that are relevant to the data of the same type in general, but are not defined specifically for the target data store. FIG. 4 shows several example “alphabet” templates for time series data, ranging from extremely simple (e.g. “linear rising”) to moderately complex (e.g. “sine”, “square”) to complex patterns frequently seen in time series data (e.g. dampening). Similar alphabet templates may be appropriately created for other kinds of data, e.g. a dictionary of words for text data, a set of images of simple objects for image data. Searches for good templates may take longer when the templates are built from alphabet templates. However, alphabet seed templates may be more easily created, with much less user input or intervention, and may capture more of the events of interest, than templates that are independently created by the user. These are only illustrative, and it is contemplated that other methods may be used to define the initial set of seed templates, as desired.

2.2 Finding Matched for Templates (Block 140 of FIG. 1)

Given a seed template or set of seed templates that form the candidate template collection of block 130 in FIG. 1, and in one illustrative embodiment, the algorithm may search through the data to find matches for those templates at block 140. Note that matches are not required to be identical to the original template. Also note that it may calculate matches only on an as-needed basis (e.g. caching matches from previous iterations through the algorithm).

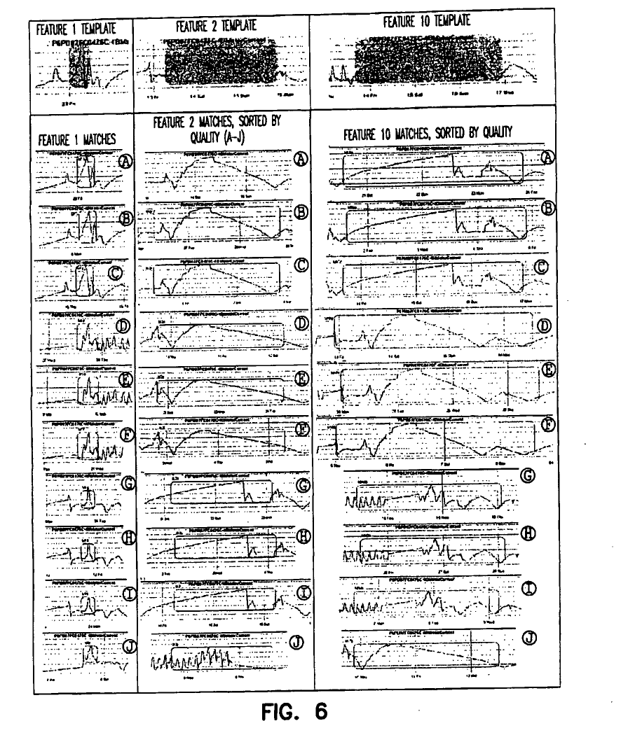

Many different search engines or the like may be used to find matches at 140, each appropriate to the data type under examination. For numerical data, one appropriate search engine is described in U.S. Pat. No. 6,754,388, entitled “Content-Based Retrieval of Series Data”, at least for its teaching with respect to searching of time series data using data patterns, which is incorporated herein by reference. In one embodiment, the search engine comprises an application written in Visual C++, and uses Microsoft, Inc. Foundation Classes along with several Component Object Model (COM) entities. The default search algorithm may use an implementation of a simple moving window correlation calculation; other search algorithms may be used and/or added by, for example, designing additional COM libraries. The application may also allow the selection of patterns viewed using a graphical user interface. In one example, and using the seed templates shown in FIG. 3, this search engine was used to find a set of matches, some of which are shown in FIG. 6. As may be observed, template T2 and template T10 have some very similar matches (reordered), while neither share matches with template T1. One potential application of the technology described in this document is to remove the redundant templates, but this is not required.

If applicable, the search for matches may be broadened by loosening the search parameters to increase the number of matches found for each template. For example, if the user specified a “case sensitive” textual search, a broader search might involve a “case insensitive” search. Similarly, word stems, misspellings, synonyms may be appropriate broadenings of a text type search. In addition, if the original template specified “adjacent” words, a broader search may allow words to be “close.” Latent semantic indexing approaches may also be a good approach for broadening a textual search. For image data, a broader color spectrum may be used, a broader region of the image, or broader shape definitions, etc. For numerical data, a broader temporal range, amplitude range, or formula coefficient range may be appropriate. The particular search parameters, and their particular broadening, may depend on the data under examination and the particular style of template. This process may increase the chance of “matching” interesting data, possibly missed by a narrower search, so that such matching data may be included when the set of templates is refined.

2.3 Clustering (Blocks 150, 151, 152 of FIG. 1)

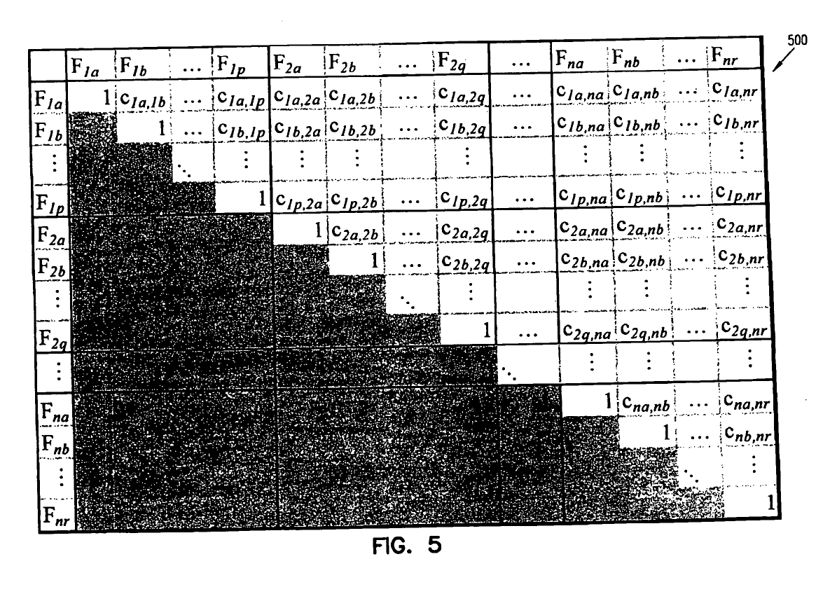

In blocks 150 and 151 of FIG. 1, similarity metrics may be used to help identify a relationship between matches (block 150 and/or the templates (block 151), as desired. An illustrative similarity matrix 500 between the matches found for a set of templates is shown in FIG. 5. In FIG. 5, Fᵢ denotes the “ith” template for the data. Fᵢⱼ denotes the “jth” match to Fᵢ. Likewise, Fₖₗ denotes the “Ith” match to template Tₖ. The term C_{ij, kl} denotes the similarity between Fᵢⱼ and Fₖₗ. The diagonal row of “1”s corresponds to the similarity of a match to itself. The similarity measures between matches (or templates) may be calculated in any number of different ways, appropriate to the data under examination. For example, textual data may utilize techniques such as those described in U.S. Pat. No. 5,963,940, and U.S. patent application Ser. No. 09/896,846, filed Jun. 29, 2001. Numerical data may utilize techniques such as a correlation factor based on dynamic time warping, uniform scaling, Lp norms, time warping, longest common subsequence measures, baselines, moving averaging, deformable Markov model templates, or any other suitable technique, as desired.

One potential use of the similarity measures is to calculate the similarity of the original seed templates Fᵢ and Fⱼ, as indicated by the connection between block 150 and block 151. For example, one can calculate the determinant of the sub-matrix (Fᵢ×Fⱼ). Alternatively, templates may be directly compared to one another, as indicated by the connection between block 130 and block 151. One embodiment may show this information directly to the user to indicate the degree of redundancy in the original set of seed templates. Referring to FIG. 6, this calculation may indicate the redundancy between template 2 and template 10.

In some embodiments, the similarity measures may be used to derive a clustering of the results. Cluster analysis is the process of grouping or segmenting a collection of objects into subsets or “clusters,” such that items within each cluster are more closely related to one another than objects assigned to different clusters. For example, the original templates may be clustered, or the returned matches can be clustered. Clustering can be used to discover clusters of matches yielding several “families” of templates that share common characteristics. These clusters may form the basis of a new collection of templates. Central to all of the goals of cluster analysis is the notion of degree of similarity (or dissimilarity) between the individual objects being clustered. Numerous techniques are known for forming clusters.

One convenient representation for hierarchical clustering is known as a “dendrogram,” which illustrates the fusions or divisions made at successive stages of the clustering process. For example, given three templates A, B, and C, the following dendrogram shows that A and B are more closely related to each other than either is to C:

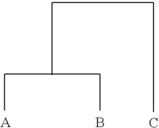

A dendrogram has the appearance of an upside down tree, with each item in the clustering being a leaf, and branches used to connect the leaves. Items occurring close to each other and connected closely by branches of the tree may be thought of as a cluster of items.

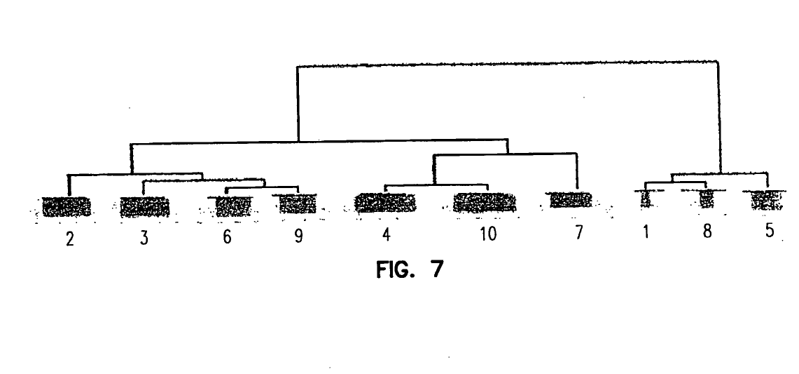

As an example, in one embodiment, we cluster the original templates of FIG. 6, and visualize them in the dendrogram 700 of FIG. 7. Dendrogram 700 shows which templates are more related to each other, meaning that they are similar to one another, and will likely return similar matches.

Using these clusters, one can thus find or define the appropriate template or set of templates that accurately return the same (or better) matches as the original (complete) set of templates. For example, a “sine wave” template illustrated in FIG. 8 at 800 might yield two clusters, one matching the concave portion at 810, and the other matching the convex portion at 820. Each cluster of matches may become a candidate “new” template. The matches in the cluster can be merged, or one of the matches in the cluster may be selected to be the new template. For example, templates T10 and T2 in FIG. 6 each have matches labeled A-J. There are many similar matches, including G, H and I matches of template T2, and matches A, B and C of template T10. Matches G, H and I of template T2 are temporally much shorter than matches A, B and C of template T10, and indicate that perhaps the two peaks of template T10 should be separated or split into two new templates during subsequent processing.

2.4 Refining Templates (Block 155 of FIG. 1)

There are numerous methods one can use for determining a new (set of) templates, depending on the data under examination. This process may be referred to as “refining.” Below, we describe in more detail several illustrative techniques for refining templates. These include changing the templates, changing, adding, or removing one or more properties or elements of a template, merging templates, calculating a difference between templates, and splitting or joining templates, among others.

For textual data, one approach that may be used is to find the most common words in each cluster that do not also appear in other clusters. For image data, one approach may be to identify common items in the color spectrum or regions of the images. For numerical data, we may average the points in the shape, or change the value of thresholds, etc.

Most of the example techniques below refer to methods for numerical time series data whose templates are described by the shape of sequential points, but it should be recognized that other refinement methods are appropriate for this and other data types, as well as other methods for defining, refining or describing templates. In addition to refining templates directly, one must also consider refining their search parameters, and/or decide when to “stop” the refinement process (potentially through a validation step).

In one illustrative embodiment, the relationships identified above may be presented to the user, and the user can use this form of guidance to directly make modifications to the templates, if desired. Commonly, the software or the user would perform the refinement step, but the approach is not limited.

2.4.1 Template Properties & Elements

One modification to a template may involve changing its elements or immediate properties. For example, in text data, we can change, add or remove keywords (it is already common practice to remove very common “stop” words; we mean changing keywords more generally). In numerical data, we can change the shape of the template. One could also alter the search parameters to change the set of returned matches.

There are several ways the shape of a numerical template may be changed. The simplest is to simply remove noise. Another is to smooth the shape. Pruning of “irrelevant” ends of the templates, or growing the template slightly may also be done. For pruning, templates T1, T5, and T8 of FIG. 3 provide good examples. The peaks and valleys of the matches can be aligned, and identified where specific ones are significantly shorter/longer than the majority. The template may be extended or pruned as appropriate to cover more of the matches, if desired.

2.4.2 Merging Templates

Another refinement method may involve merging two or more templates. In one illustrative technique, two items on each branch of a dendrogram may be merged. At each step of the merge, two siblings that are most similar to each other may be chosen. At each step the decision may be made whether it makes sense to merge two siblings based on intra-item similarity of the resulting cluster, inter-cluster similarity/difference, and/or validation of the resulting collection (described in Section 2.5). Optionally, a biasing factor may be taken into account going up the tree, potentially reducing the effect of more distant templates. In a second illustrative technique, one of the two leaf templates may be selected as the new template.

For merging numerical templates, a simple approach is to average two templates on a point-by-point basis. Since numerical templates are likely to be of different lengths they can be stretched/squeezed so that they are both of the same time length, and then averaged. As an alternative, the peaks and valleys of different matches may be aligned. It might also be the case that “most” of the templates in the cluster have a specific shape, and “just a few” have that same shape with a small extension (or reduction, or noisy point, etc). (e.g. template T5 of FIG. 3 when compared to templates T1 and T8.) These cases outliers may be identified and ignored: e.g. by aligning the peaks/valleys to easily see the extra points, or calculating the distribution of values on each point. There are many other techniques for outlier identification which may be utilized, as desired.

2.4.3 Differencing Templates

Another illustrative refinement technique may involve calculating the difference between clusters. For textual data, one might wish to explicitly rule out keywords that appear in other clusters, and create a new template(s) constructed of “good keywords ‘and not’ bad keywords,” e.g. “windows and glass and not computer.”

It may also be relevant to construct queries that eliminate false positives, a common problem in many search domains. These are situations when the user's search parameters are somehow “too flexible,” and the algorithm finds inappropriate matches. In numerical data, reasons for false positives might include the shape of the template, or the settings of a specific search parameter like amplitude range or resolution.

In one example embodiment, a user may be asked to identify the false positives. The characteristics of the false positives can be analyzed and used to refine a new template. For example, in much the same way that the common characteristics of templates may be merged to create a “generalized” template, characteristics of the false positives can be subtracted from the “generalized” template created by the true positives. For example, in numerical data, a template may be shortened by identifying irrelevant tails.

2.4.4 Joining Templates

There may be occasions that a useful template can be created by joining two templates. That is, there may be two templates that together form a match of interesting data. For example, in text data, a better template may be formed by using multiple words or phrases. If desired, the grammar of the text may be incorporated, as it may significantly affect meaning.

FIG. 9 illustrates a simple example for numerical data, where a join occurs by connecting two parts of a square wave. In this numerical data, one opportunity for joining templates may occur when clusters of matches are always co-located in time. For each match m in a cluster for the first template, there should be exactly one match n in a cluster for the second template that follows it closely (almost exactly) in time. If almost all of the matches m have a corresponding match n, then a “joined” template may be posed as a new template. Alternatively, if the search algorithm uses the alphabet templates to find initial matches, the user or algorithm could examine those returned matches to create better templates. For example, the algorithm may return all the left-square-wave matches, and the user or algorithm may extend the template to create the joined square wave shown in FIG. 9.

2.4.5 Splitting Templates

Another illustrative refinement method involves splitting templates. In some cases, a template may be more complex than necessary, or merge multiple different search ideas. In image data, for example, the sample image might have contained two (or more) specific objects. It might be the case that the user is looking for only one (or a subset) of those objects, and hence it would be useful to identify those separate items and create multiple new templates, one for each potential item of interest.

In numerical data, for example, a pattern may return better matches by splitting it into its constituent parts, e.g. a sine wave into its convex part and its concave part. As an additional example, templates T10 and T2 in FIG. 6 have many similar matches, including matches G, H and I of template T2 and matches A, B and C of template T10. Matches G, H and I of template T2 are temporally much shorter than matches A, B and C of template T10, and indicate that perhaps the peaks of template T10 should be separated or split into two or more new templates.

2.4.6 Handling Search Parameters

Search parameters may also be modified as part of the template refinement process. There are multiple approaches that may depend on the data under examination. One simple approach may be to average each value—for example in numerical data to average the “amplitude shrink” parameter, or in text to alter the relative importance of nouns and verbs. Another approach may be to take the “extremum” values—that is, the minimum and/or maximum values (e.g. the minimum value of “amplitude shrink,” and the maximum value for “amplitude stretch”).

In one illustrative embodiment, the relative values could be considered. As one example, consider when templates A and B for numerical data might have different amplitude shrink values, but yield the same final range of matches. If template A's lowest γ value is 0 and highest γ value is 1.0, with amplitude shrink of 0.5 (that means a match could be found wherein its highest γ value would be 0.5 greater than its lowest γ value). Template B may range from −1.0 to 1.0, with amplitude shrink of 0.25 (meaning that a match could be found wherein its highest γ value would be 0.5 greater than its lowest y value). Then as one possibility, the amplitude shrink of merged template C may be set to yield a minimum range of 0.5.

Also, in the motor current data shown in FIG. 6, match j of template T2 and matches G, H and I of template T10 are probably false positives. With these marked, the “resolution” search parameter may be increased so that the “noise” factor of these matches reduces their quality. For example, in the motor current data whose templates illustrated in FIG. 3, there is no interest in any matches whose maximum point is lower than 0.5 Amps (total range is 0 to 1.2 Amps, 0.2 is considered “nominal”). If the template had a maximum point of 0.75, and the user sets the amplitude constraint to 0.5, then a match can be found with a maximum point of only 0.375 (0.5 times 0.75). In this example, the lowest amplitude range which should be used is 0.666 (0.5 divided by 0.75). When the user marks low amplitude matches as false positives, this information can be used to bound the lowest amplitude range. This invention may be used to automate at least some of these tasks, if desired.

2.4.7 Refining Stopping Criteria

When refining templates, it is important not to create poor refinements. One mechanism to control the process is to monitor the similarity measures. One can measure the similarity between the newly refined template/matches and the remaining templates/matches, or one can choose to merge all the items in the original clusters. The measures used might be the intra-cluster distance, or distance of individuals to the centroid of the cluster, inter-cluster distance, or a threshold of false positives, or other measure.

For example, when merging items in a cluster, one can merge the most similar siblings; the process may stop when the potential merges are dissimilar, that is, until the similarity of items in the cluster reaches a certain threshold.

One risk lies in building generalized search templates in cases when clusters being merged are not closely related. One potential mitigation approach for this risk is to provide users with several alternatives for merged templates that will include such choices as average, maximum/minimum combination, logical “or”, etc. In this case, the software tool performing the above algorithms may be an aid for users, rather than a fully automated tool.

2.5 VALIDATING TEMPLATES (Blocks 160, 170, 172, 174 of FIG. 1)

An additional step in creating refined templates may include validating the newly refined templates, as shown at block 160 of FIG. 1. In general, a goal may be to create a template collection that improves the match results for the user. Generally, if the new template(s) yield worse results than the original set, then the user has not been helped. More specifically, goals may include finding all the matches that the original templates did, capturing any false negatives and eliminate false positives, and/or changing the shapes of the templates somewhat to capture the user's broader intent (e.g. eliminate noise). The new template (or new set of templates) may be validated to see that they meet the user's needs. An individual template may be validated or a new template collection may be validated. For example, if the user provides one initial “seed” template, one or more new template(s) (and/or search parameters) may be validated. If several seed templates were used, the new collection of templates may be validated.

In many domains, we may have a metric describing how to calculate the quality of the template(s). Alternatively, if match quality is known, then one can directly measure the quality of the new template(s). In other domains, it may be difficult to determine whether the new template(s) yield better results than the original template(s). It is likely in these domains that the user can provide information about the quality of matches, including their relative quality, and identification of false positives. For example, in time domain data we may have a list of time durations for events of interest. In time series data, an event is an identified time segment of interest. This information can be considered a type of ground truth. If the search does not match these events of interest after modifying templates, we use this objective measure to reject the new templates.

If the validation step shows that the newly refined template(s) are “bad,” then one may choose to undo the most recent modifications in block 170.

At block 172, the illustrative algorithm may verify whether there are more refinement methods available, and if so, continues to block 174. Otherwise, it stops the refinement process and continues to block 175.

If at block 174 the current (set of) template(s) is significantly different from the original candidate collection, one returns to block 130, which will lead to recalculating matches based on the new templates, recalculating similarity scores and clusters, and then possibly providing further refinements. Otherwise, if the new template is only a minor variation from the original set, one can continue refining at block 155.

Note that the refinement module (block 155 of FIG. 1) may be able to use validation information to improve refinements. For example, if the refinement “lost” several important matches as compared to the original template(s), then the refinement process may ensure that common features of the “lost” matches are incorporated in the new template.

In one illustrative embodiment, a set of templates may be derived from a (set of) seed template(s). One potential problem is that new templates derived from matches of these seed(s) may not actually capture all of the events of interest. The user's (or alphabet's) templates may not use broad enough search criteria to capture all of the events. For example, the user (or alphabet) may not have created an important shape.

In general, it may be difficult to measure whether the template(s) cover all data of interest, because it would take a much deeper understanding of the domain and the user's task than can readily be obtained. For example, all the numerical template examples in FIG. 3 were related to the motor current being high. Based on only these templates, the algorithm would not find events when motor current was abnormally low (e.g. off for extended periods). Similarly, if the user had not provided a template like T1, T5 or T8, the algorithm would not find events that match this new concept. However, it can be ascertained whether all the events of interest that the user “hinted” at were captured.

If a general “alphabet” is used, a broader coverage of data of interest—possibly even complete coverage—may be achieved. For example, if the alphabet in text data is a set of terms from a dictionary, then this approach can build phrases or groups of nouns. Similarly, if the templates in FIG. 3 did not include T1, T5, or T8, a “sine wave” alphabet template could be used to find these events. With a different alphabet collection for this numerical data, a “linear rising” template could find an initial steep rise, and either the user could create a new “better” template from area around the returned matches, or the techniques herein may be used to “join” a series of templates e.g. “rise/steep drop/steep rise/steep drop/steep rise/drop.” Note that validation of templates for these broader concepts may be helpful.

2.5.1 Identifying Disjoint Pairs (Block 180 of FIG. 1)

For certain kinds of data, it may be appropriate to create templates that model “disjoint pairs.” That is, two independent templates in the collection frequently appear “together,” but are not related enough to be captured in the above refinement process. For example, in natural language text, we may have two or more phrases that independently find interesting data, but together are more immediate and relevant, e.g. “middle east” and “terrorist activity.” In transactional data, we may expect purchase groupings to be sequential, e.g. a purchase of (digital camera and card reader) followed later by a purchase of (printer and image processing software). In numerical data, we may expect two or more events to occur (possibly on different data streams) with some time lag between them.

One illustrative approach for creating disjoint pairs is to use a pattern discovery algorithm to find sub-sequences of templates that occur frequently or templates whose co-occurrences are correlated. For example, in numerical data, there may be cases where it is expected that an event A will be followed by event B with some delta time Δt. When Δt is greater than zero (there may be significant activity between events A and B), a temporally joined template may be created, which is referred to as a disjoint template (note that if Δt is close to zero, then one may simply join the templates).

In general, for each match m in a cluster for the first template, there should be a match n in a cluster for the second template that follows it (for time series data, we might expect n to follow m with some Δt). If almost all of the matches m have a corresponding n, then a “joined” template may be posed as a new template. In some cases, one may have to be careful that the same n is not used multiple times for a single m. A pairwise matching algorithm may be used to find the optimal pairings, e.g. so that Δt doesn't differ too much if we want to minimize the variation on Δt.

Note that disjoint templates may occur over multiple variables (data streams or types), which is referred to as a multivariate combination. For example, a rise in temperature at one sensor location may be followed some time later by an increase in pressure at another sensor location. Similarly, a rise in value of a financial stock may be followed by a rise in other stocks. Multivariate combinations may also occur over widely disparate data types as well. For example, there is often a correlation between seasons and purchasing patterns. Similarly, sensor readings for an integrated sensor system (such as a security system or refinery control center) may correlate to records in call center databases.

It might be relevant to create “not” queries, A is not followed by B. In this case, the exception to the above rule should be noted: for each m that does not have a corresponding n, a new template may be posed. Note that since this algorithm may be iterative, one may create disjoint queries composed of many variables (i.e. not just pairs).

2.6 Notes & Alternative Uses

The techniques described herein may range from almost fully automatic, to a tool that guides the user through the search space. In one illustrative embodiment, the tool is more likely to be used as a user aid (rather than strictly automatic). In this embodiment, the identified relationships may be presented to the user, and the user may perform any desired template refinement. Alternatively, validation results may be presented to the user, who can select or refine new templates as s/he chooses. For example, a graphical user interface may show a “new template” and “candidate matches,” and the user can select the new template to add to the useful collection if desired. Or, the user interface may provide an interactive (e.g. iterative) mechanism by which the user starts with one (set of) templates, the tool finds a new (set of) templates, the user rates the results, etc. In an embodiment that is almost fully automatic, one might expect, for example, the algorithm implementers to set thresholds for certain decisions, e.g. maximum smoothing on a curve, or minimum letters in a word, or minimum inter-cluster distance.

Alternatively, or in addition, the clusters generated by block 152 may be directly of use to the user. For example, if the user generates a query “windows” in an internet search engine, current technology presents a list of matching web pages, and possibly a simple modification of the query (e.g. to suggest alternative spellings). Instead of presenting each of the matching web pages, an internet search engine might instead suggest the two alternate queries, “windows computer” and “windows glass,” allowing the user to understand the natural clusters in the data, and thereby improve their search results. Similarly, if the user generates a query of “tomato” on a shopping website, current technology may present a list of categories (store sections) that the tomato products appear in; this list of categories was manually generated. Using the technology described herein, the website could automatically calculate and present the clusters of items. Similarly, if a user is using a hand-drawn sketch to search through a database of facial photographs (e.g. police identification), this technology might present the clusters of faces that match specific facial features (e.g. prominent brow line or square jaw).

The clustering approach can be used to navigate through the space; for example a first query at a shopping website might be “civil war.” Two clusters returned might be “books” and “movies.” Within books, clusters might be “adult fiction,” “children's historical,” “historical” and “retrospectives.” Within historical, clusters might be “figures,” “battles” and “events,” or “European,” “American” and “African.” A search interface based on this kind of auto-generated cluster is likely to be more user friendly. It may also be the case that the user wishes to understand which parameter settings provide the most effective search results. It is likely that different clusters will have different search properties or parameters, for example, each branch in the dendrogram may represent a parameter setting, e.g. left branch sets amplitude scaling, while right is temporal scaling, or left branch represents the matches to half of the template while the right branch represents matches to the other half of the template.

While some of the description herein relates to clustering the matches to templates (via block 140 of FIG. 1), it is clear that one could also cluster the templates directly (via block 151 of FIG. 1), thereby providing a method to identify relevant or related characteristics. For example, the user may also like to know which templates, based on the original set, form the smallest set of templates that yields accurate results (accurate meaning, for example, “all the events of interest” with a minimal set of false positives). This analysis requires knowing, among other things, the degree of redundancy among the templates.

3. Conclusion

Templates are used to search through stores of data (databases) to return desired results from the data. The templates are defined and/or refined by, for example, identifying closely related templates and/or matches, extracting common or key elements, and/or generalizing or modifying templates. Similarity metrics may be used to determine relationships between templates and/or their matches to facilitate defining and/or refining templates to produce more effective templates. Such metrics may aid in the creation of clusters of matches or templates that share common characteristics, if desired. A dendrogram or similarity matrix may be constructed to help identify the relationships between the clusters, matches and/or templates. Using clusters of closely related matches or templates, common elements may be extracted to create refined or generalized sets of templates that may be more effective for searching the data.

Several different techniques for forming new templates may be used. Search parameters of the templates may be modified, such as by changing an amplitude or other parameter of a template. Templates may be merged based on similarity, or one of two similar templates may be selected for use. One technique involves determining differences between templates and modifying a template to remove false positives. Templates may also be joined if the desired matches are more complex or incorporate features from two templates, or they may be split if the desired pattern is simpler than the template.

Templates may be validated to ensure that new templates are at least as good as previously used templates. If not as good, changes may be undone and the templates further modified and validated again prior to adding to a recommended template collection.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. A computer assisted method, comprising:
providing one or more templates for use in identifying matching data in a database;
running the one or more templates against the database to identify matching data elements for each of the one or more templates; and
identifying one or more relationships in the matching data elements.

2. The computer assisted method of claim 1, further comprising:
defining one or more new templates based at least part on the identified one or more relationships in the matching data elements.

3. The computer assisted method of claim 2, further comprising:
running one or more templates, including one or more of the new templates, against the database to identify new matching data elements; and
identifying one or more relationships in the new matching data elements.

4. The computer assisted method of claim 1, wherein at least a portion of the matching data elements is used to at least partially define at least one of the one or more new templates.

5. The computer assisted method of claim 1, further comprising:
defining one or more refinements to at least one of the one or more templates based at least part on the identified one or more relationships in the matching data elements.

6. The computer assisted method of claim 5, wherein at least some of the templates include a number of template elements, and the one or more defined refinements includes adding, removing and/or changing one or more of the template elements.

7. The computer assisted method of claim 5, wherein the one or more defined refinements include pruning one or more of the templates.

8. The computer assisted method of claim 5, wherein the one or more defined refinements include extending one or more of the templates.

9. The computer assisted method of claim 5, wherein the one or more defined refinements include averaging and/or concatenating two or more of the templates.

10. The computer assisted method of claim 5, wherein the one or more defined refinements include ceasing to use a template.

11. The computer assisted method of claim 5, wherein the one or more defined refinements include splitting a template into two or more templates.

12. The computer assisted method of claim 5 wherein the one or more defined refinements are at least partially defined by a user.

13. The computer assisted method of claim 5 wherein the one or more defined refinements are at least partially defined by software running on a computer.

14. The computer assisted method of claim 5, further comprising the step of validating the one or more defined refinements.

15. The computer assisted method of claim 14 wherein the validating step is performed at least in part by a user.

16. The computer assisted method of claim 14 wherein the validating step is performed at least in part by software running on a computer.

17. The computer assisted method of claim 5, further comprising:
running one or more templates, including one or more of the refined templates, against the database to identify new matching data elements; and
identifying one or more relationships in the new matching data elements.

18. The computer assisted method of claim 1 further comprising:
recommending a certain collection of templates based at least part on the identified one or more relationships in the matching data elements.

19. The computer assisted method of claim 1 wherein at least one of the one or more templates is user defined.

20. The computer assisted method of claim 1 wherein at least one of the one or more templates is a predefined template selected from an alphabet of predefined templates.

21. The computer assisted method of claim 1 wherein the relationship identified by the identifying step is established, at least in part, by a measure of similarity between two or more of the matching data elements.

22. The computer assisted method of claim 1 wherein the relationship identified by the identifying step is established, at least in part, by a measure of similarity between two or more sets of matching data elements.

23. The computer assisted method of claim 22 further comprising the step of constructing a similarity matrix that includes at least a measure of similarity between two or more sets of matching data elements.

24. The computer assisted method of claim 22 further comprising using at least two measures of similarity to construct a dendrogram data structure that defines, at least in part, at least one of the relationships in the matching data elements.

25. The computer assisted method of claim 22 further comprising using at least one measure of similarity to define one or more clusters of the matching data elements.

26. A computer assisted method, comprising:
providing a collection of two or more templates for use in identifying matching data in a database;
running two or more of the templates against the database to identify corresponding matching data; and
identifying a relationship between the corresponding matching data of at least two of the two or more templates.

27. The computer assisted method of claim 26 further comprising identifying a relationship between two or more of the templates based on the identified relationship between the corresponding matching data of the least two of the two or more templates.

28. The computer assisted method of claim 27 further comprising defining a new template or one or more refinements to one of the templates based at least in part on the identified relationship between the at least two of the two or more templates.

29. The computer assisted method of claim 26 further comprising defining a new template or one or more refinements to one of the templates based at least in part on the corresponding matching data of the least one of the two or more templates.
